(19) United States
(12) Patent Application Publication
(10) Pub. No.: US 2015/0174994 A1
(43) Pub. Date: Jun. 25, 2015

(54) PROTECTION ELEMENT FOR AT LEAST ONE PORTION OF A MOTOR VEHICLE BODY

(71) Applicant: Confezioni Andrea S.r.l., Varese (IT)

(72) Inventor: Andrea Tavelli, Castelveccana (VA) (IT)

(21) Appl. No.: 14/576,393

(22) Filed: Dec. 19, 2014

(30) Foreign Application Priority Data
Dec. 20, 2013 (IT) MI2013A 002172

(51) Int. Cl. B60J 11/04

(52) U.S. Cl. CPC B60J 11/04

(57) ABSTRACT

The present invention refers to an element for protecting at least one portion of a motor vehicle body, which comprises a cover for protecting the at least one portion of body provided with a perimetrical bonding portion in the form of a strip having a first end and a second end respectively proximal and distal with respect to the protection cover and is characterised in that the perimetrical bonding portion is connected to the protection cover along a first connection line arranged at an intermediate position with respect to the two ends.

### CROSS REFERENCE TO RELATED APPLICATION

This application claims the benefit of and incorporates by reference herein the disclosure of Italian Patent Application No. MI2013A 002172, filed Dec. 20, 2013.

### BACKGROUND OF THE DISCLOSED EMBODIMENTS

The present invention refers to a protection element for at least one portion of a motor vehicle body.

Nowadays, it is known to at least partially cover the body of motor vehicles parked in parking areas of car dealers or of manufacturing plants with different types of covers, generally made of paper-like material, which protect the external finishing of the body itself from weather events, vandalism and accidental bumps.

Such protection covers are usually provided with perimetrical bonding portions in the form of a strip that are suitable for being applied onto the painted portions of the body or onto the glass of the windows or windshield or back window.

Such perimetrical portions thus have a first end that is proximal with respect to the protection cover and that is connected to the cover itself along a connection line through stitching or thermo-welding, and a second end that is distal with respect to the protection cover and that is applied onto the body or onto the glass of the windows or windshield or back window.

The perimetrical portions, moreover, follow the profile of the protection cover; therefore, in the case in which the cover covers a roof of a motor vehicle, the corresponding perimetrical bonding portion has angular portions, for example, at the upper corners of the windshield.

Once motor vehicles have been covered with the aforementioned protective covers, said motor vehicles are generally taken to the car dealers or to car parks of plants on articulated lorries, or on trains, or on ships or other means of transport.

In many cases during transportation the covered motor vehicles are outdoors, thus exposed to wind and/or to strong air currents that develop during the movement of the means of transport. In such cases, and in particular under high speed or strong wind conditions, the air can penetrate into the space between the protection cover and the body and it tends to swell the cover itself.

The anchoring of the cover under these conditions is therefore strongly stressed and it may occur that the stress caused by the air inside the protection cover is so strong that it detaches the bonding portion from the body or from the glass on which it is applied.

This occurs especially at the angular portions of the protection cover and more in particular at the angular connection between the protection cover and the first end of the bonding portion. Indeed, the adhesion strength exerted by the bonding portion at the angular connections is much less than that exerted by the same bonding portion at the second end since the amount of the applied adhesive material is less. Therefore, in the cases of strong stress, the first end of the bonding portion is the first to be detached from the area in which it is applied. If the stress of the air continues, the bonding portion gradually detaches from the area in which it is applied until it is completely detached.

A need therefore exists to avoid the drawbacks mentioned above and in particular to conceive a protection element for at least one portion of a motor vehicle body that is capable of withstanding the aforementioned strong stresses without being detached from the body to a greater extent with respect to known protection elements.

### SUMMARY OF THE DISCLOSED EMBODIMENTS

In an embodiment, a protection element for at least one portion of a motor vehicle body is provided. The protection element includes a cover for protecting the at least one body portion provided with a perimetrical bonding portion in the form of a strip having a first end and a second end respectively proximal and distal with respect to said protection cover, wherein the perimetrical bonding portion is connected to the protection cover along a first connection line arranged at an intermediate position with respect to the two ends.

Other embodiments are also disclosed.

### BRIEF DESCRIPTION OF DRAWINGS

The characteristics and the advantages of a protection element for at least one portion of a motor vehicle body according to the present invention shall become clearer from the following description, given as an example and not for limiting purposes, with reference to the attached schematic drawings in which:

FIG. 1a is a schematic perspective view of a protection cover of the known type applied onto a motor vehicle;

FIG. 1b is a schematic side view of one portion of the protection cover of FIG. 1a;

FIG. 2a is a schematic partial perspective view of a protection element according to a first embodiment of the present invention;

FIG. 2b is a schematic side view of a portion of the protection element of FIG. 2a;

FIG. 3a is a schematic partial perspective view of a protection element according to a second embodiment of the present invention;

FIG. 3b is a side schematic view of one portion of the protection element of FIG. 3a;

FIG. 4 is a schematic partial perspective view of a protection element according to a third embodiment of the present invention;

FIG. 5 is a schematic view of a protection element according to the present invention provided with a secondary bonding element;

FIG. 6 is a graph showing the variation in load/pulling force as a function of the stretching that is measured through a dynamometer by considering a sample of a known protection element, a sample of a protection element like that of FIG. 2a and a sample of a protection element like that of FIG. 3a; in this graph, the curve corresponding to the behaviour of the known protection element is indicated with a continuous line, the curve corresponding to the behaviour of the protection element of FIG. 2a is indicated with a broken line and the curve corresponding to the behaviour of the protection element of FIG. 3a is indicated with a dotted line.

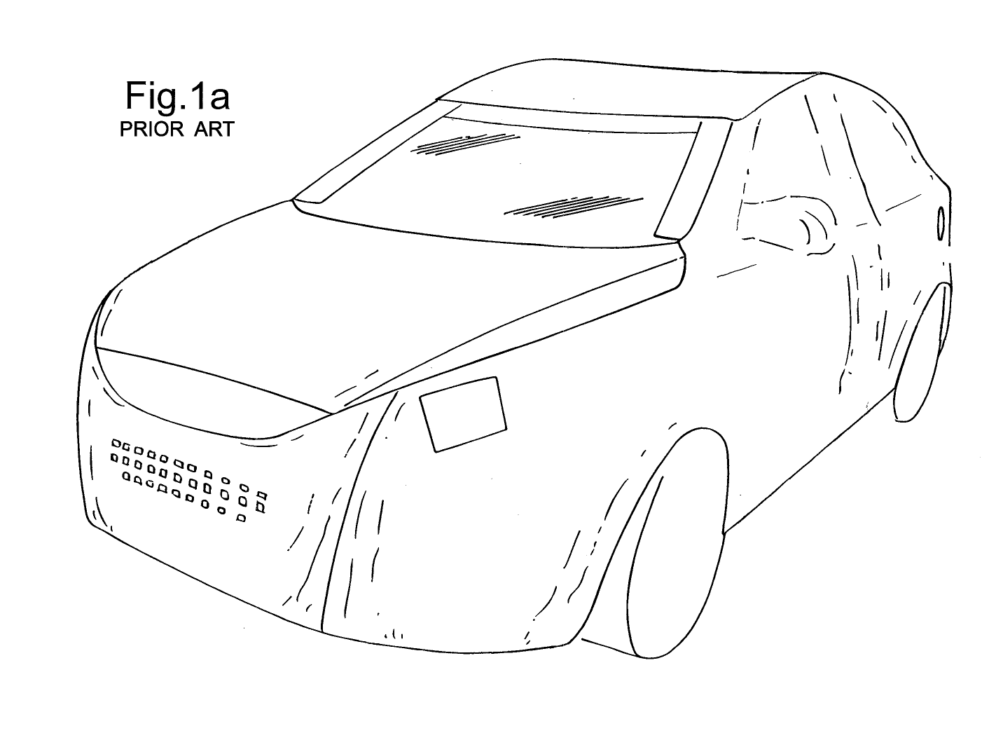

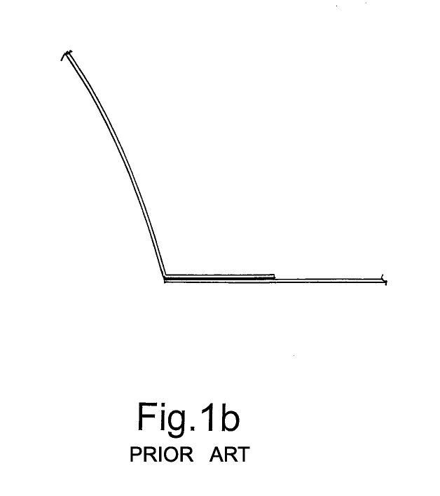

### DETAILED DESCRIPTION OF THE DISCLOSED EMBODIMENTS

With reference to the figures, an element is shown, wholly indicated with reference numeral 10, for protecting at least one portion of a motor vehicle body.

The portion of body to be protected can be the motor bonnet, the roof, or the hood or a car door and so on.

The protection element 10 comprises a cover for protecting 11 the at least one portion of body provided with a perimetrical bonding portion 12 in the form of a strip that is suitable for anchoring the protection cover 11 onto the body portion to be covered.

The perimetrical bonding portion 12, in detail, has a first end 13 and a second end 14 that are respectively proximal and distal with respect to the cover 11 itself.

The protection cover 11 can advantageously be shaped so as to match the portion of body that it is intended to cover.

As already mentioned previously, the perimetrical portion 12 follows the profile of the protection cover 11; therefore, for example in the case in which the cover 11 covers a roof of a motor vehicle, the corresponding perimetrical bonding portion 12 has angular portions at the upper corners of the windshield.

Such a perimetrical bonding portion 12 may be applied onto portions of the body that are painted or made of glass like for example the windshield or the windows.

In an embodiment, the perimetrical bonding portion 12 is provided with one layer of adhesive material on which a removable protective film is applied.

In an embodiment, the adhesive material can be a glue for paints which, once the bonding portion has been removed, does not leave any trace on the adhesion area.

The perimetrical bonding portion 12 can, in another embodiment, be made like a strip of biadhesive material.

In an embodiment, the perimetrical bonding portion 12 is connected to the protection cover along a first connection line 16 that is arranged at an intermediate position with respect to the two ends 13 and 14.

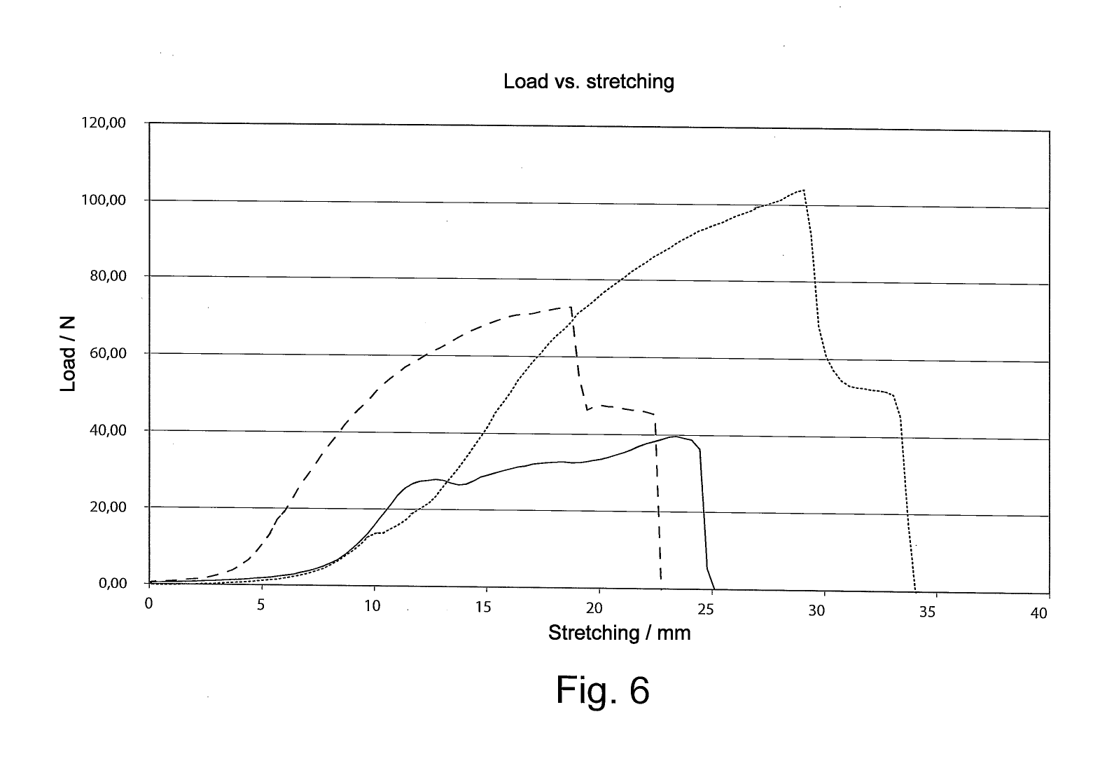

In such a way the resistance offered by the bonding portion against pulling stresses is considerably increased as it is possible to see from FIG. 6. From such a graph it is possible to see, in particular, that the first end 13 of the bonding portion 12 detaches form the application surface when the pulling force reaches a value of around 70-72 N. Differently, in the case in which the same test is carried out on a sample of a known protection element the first end of the bonding portion is detached from the application surface when the pulling force reaches a value of around 40 N.

In an embodiment, the distance between the first connection line 16 and the first end 13 is less than half of the distance between the ends 13 and 14.

By gradually moving the first connection line in positions that are increasingly distant from the first end, the resistance to the pulling force increases up to a maximum value that corresponds to the equidistant position between the two ends 13 and 14. Once such a position has been passed, the resistance to the pulling force gradually decreases as the first connection line moves towards the second end 14.

In an embodiment, the perimetrical bonding portion 12 comprises a plurality of adhesive portions 17 that are arranged side by side in succession with each other.

In such a case, the first connection line 16 is arranged between two portions 17 of the aforementioned plurality of adhesive portions.

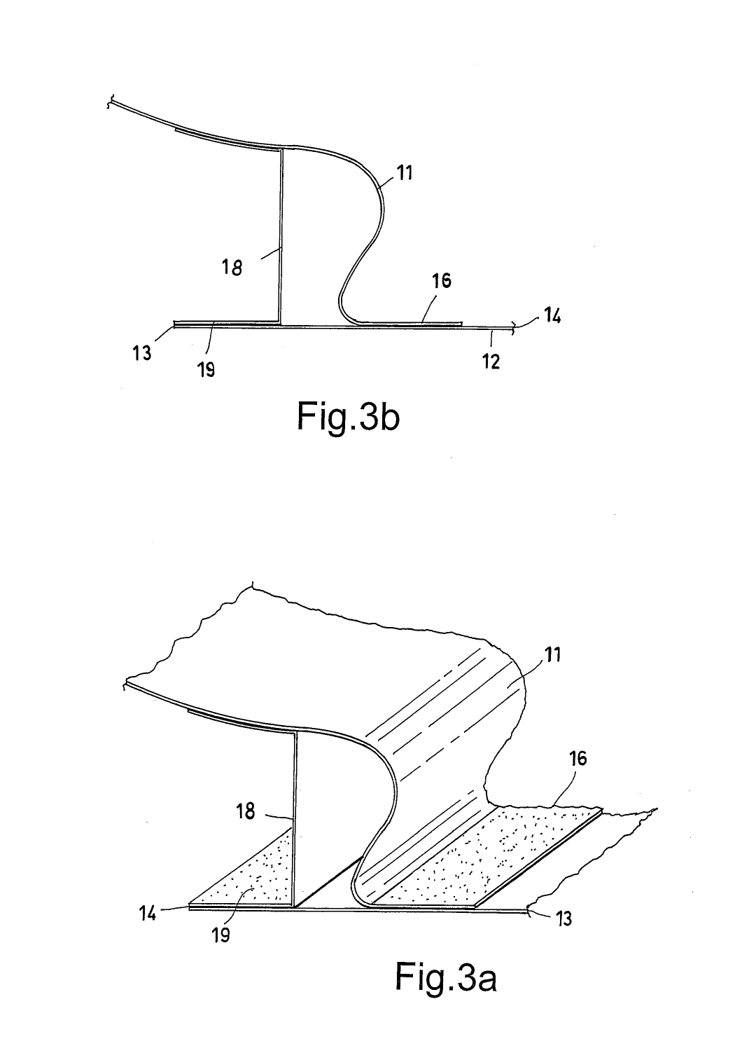

In the embodiment illustrated in FIGS. 4a and 4b, the bonding portion 12 comprises two adhesive portions that are arranged side by side in succession and the first connection line 16 is arranged in the interspace between such adhesive portions 17.

In an embodiment, the protection element 10 comprises at least one reinforcement element 18 that is connected on one side to the protection cover 11 and on the other to the perimetrical bonding portion 12 along a second connection line 19 that is arranged between the first end 13 and the first connection line 16.

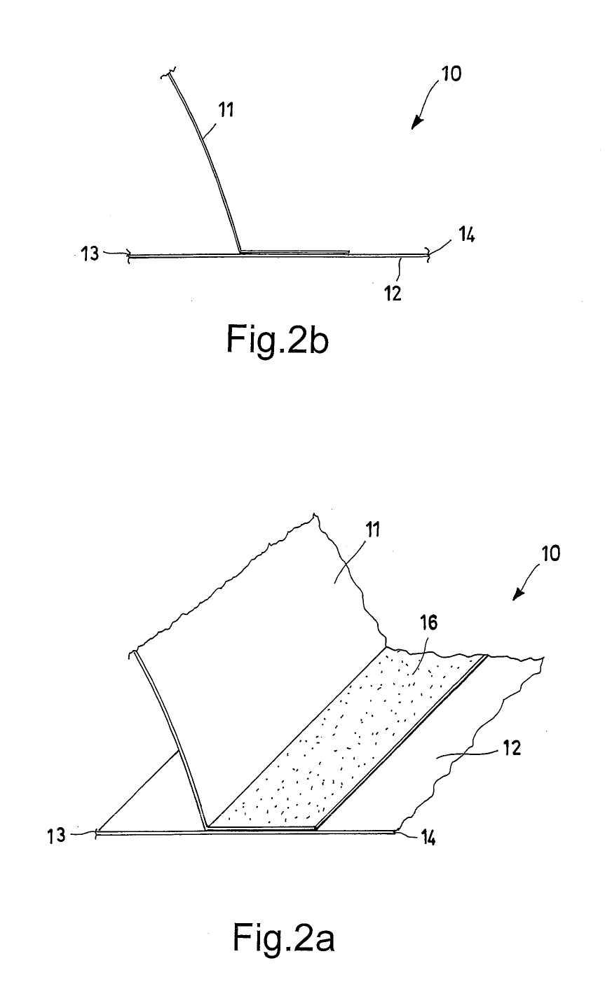

As it is possible to see in FIG. 3a or 3b, the reinforcement element 18 can be made as a strip made up of the same material as the protection cover 11.

The presence of the reinforcement element 18 increases the resistance to the pulling force of the protection element 10. Indeed, as it is possible to observe from FIG. 6, with reference to the embodiment that provides for the presence of the reinforcement element 18, the first end 13 of the bonding portion 12 detaches from the surface of application when the pulling force reaches a value of beyond 100 N which is considerably higher than the value observed in the case in which the protection element 10 does not comprise any reinforcement element 18.

It is worth underlining that the graphs of FIG. 6 are obtained by analysing samples of protective elements made with the same materials, and therefore having also bonding portions with the same adhesive material. Therefore the results of the tests carried out can be validly compared.

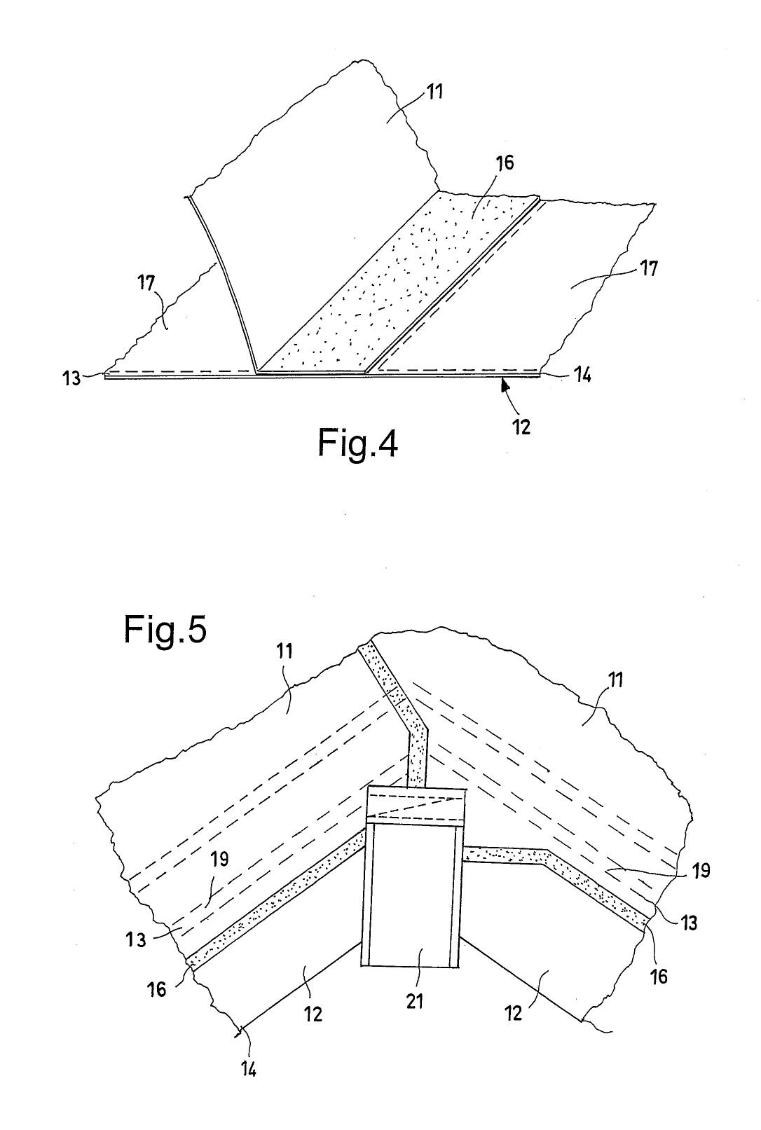

In an embodiment, the protection element 10 comprises at least one secondary bonding element 21 connected to the protection cover 11 on one side and arranged to be anchored to the body on the other; in particular, as can be seen in FIG. 5 the secondary bonding element 21 at least partially projects over the perimetrical bonding portion 12 when it is anchored to the body.

In particular, the secondary bonding element 21 is applied in an embodiment at the angular portions of the protection cover 11; more in general, however, the secondary bonding element 21 can be applied at any perimetrical point of the protection element 10.

Such a secondary bonding element 21 improves the seal of the anchoring of the protection cover 11 on the body of the motor vehicle and at least partially protects the outer surface of the bonding portion 12 from atmospheric events.

In an embodiment, the first 16 and the second 19 connection line are obtained by stitching.

In an embodiment, the first 16 and the second 19 connection line are obtained through thermo-welding.

From the description made the characteristics of the protection element for at least one portion of a motor vehicle body object of the present invention are clear, just like the relative advantages are also clear.

Indeed, thanks to the intermediate position between the two ends of the bonding strip of the first connection line it is possible to increase the resistance to the pulling force caused by the action of the air penetrating inside the protection cover during the transport of the covered motor vehicle.

Moreover, by providing the protection element according to an embodiment with one or more reinforcement elements the resistance to the aforementioned pulling force is even greater.

Finally, it is clear, that the protection element for at least one portion of a motor vehicle body thus conceived can undergo numerous modifications and variants, all covered by the invention; moreover, all the details can be replaced by technically equivalent elements. In practice, the materials used, as well as the dimensions, can be any according to the technical requirements.

What is claimed is:

1. A protection element for at least one portion of a motor vehicle body comprising:
a cover for protecting said at least one body portion provided with a perimetrical bonding portion in the form of a strip having a first end and a second end respectively proximal and distal with respect to said protection cover, wherein said perimetrical bonding portion is connected to said protection cover along a first connection line arranged at an intermediate position with respect to said two ends.

2. The protection element according to claim 1, further wherein the distance between said first connection line and said first end is less than half the distance between said ends.

3. The protection element according to claim 1, further wherein said perimetrical bonding portion comprises a plurality of adhesive portions arranged side by side in succession.

4. The protection element according to claim 3, further wherein said first connection line is arranged between two portions of said plurality of adhesive portions arranged side by side.

5. The protection element according to claim 1, further comprising at least one reinforcement element connected on one side to said protection cover and on the other to said perimetrical bonding portion along a second connection line arranged between said first end and said first connection line.

6. The protection element according to claim 1, further comprising at least one secondary bonding element connected to said protection cover on one side and arranged to be anchored to said motor vehicle body on the other side, said secondary bonding element at least partially overlapping said perimetrical bonding portion when it is anchored to said body.

7. The protection element according to claim 6, further wherein said secondary bonding element is applied at the angular portions of said protection cover

8. The protection element according to claim 1, further wherein said first and said second connection lines are obtained by stitching.

9. The protection element according to claim 5, further wherein said first and said second connection lines are obtained through thermo-welding.
